(19) United States
(12) Patent Application Publication
(10) Pub. No.: US 2009/0113085 A1
(43) Pub. Date: Apr. 30, 2009

(54) FLUSHING WRITE BUFFERS

(76) Inventors: Chris J. Banyai, Chandler, AZ (US); Eric J. Dahlen, Sherwood, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/924,515

(22) Filed: Oct. 25, 2007

(51) Int. Cl. G06F 13/14

(52) U.S. Cl. 710/53

(57) ABSTRACT

A first node to cause flushing data units stored in a write buffer of a second node to a memory of the second node. While using a pin-based approach, the central processing unit (CPU) of the first node may activate a first pin coupled to a second pin of the second node that may cause a sequence of operations to flush the write buffer. While using a control-register based approach, the CPU or the memory controller hub (MCH) may configure the control register using an inter-node path such as the SMBus or a data transfer path that may cause a sequence of operations to flush the write buffer. While using an in-band flush mechanism, the CPU may send a message over the data transfer path after transferring the data units that may cause a sequence of operations to flush the write buffer.

### BACKGROUND

A redundant node may be provisioned in a computer system to provide continued service and data protection even if a main node fails. To provide data protection, the data from the memory of the main node may be written into write buffers (WB) provisioned in the redundant node through interconnects such as the peripheral component interconnect-express (PCI-e). The data transferred from the main node may linger in write buffering structures within the redundant node before being written to the memory. The data that lingers in these write buffers may be lost if the redundant node is powered down.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system 100.

### DETAILED DESCRIPTION

The following description describes flushing write buffers. In the following description, numerous specific details such as logic implementations, resource partitioning, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, and digital signals). Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

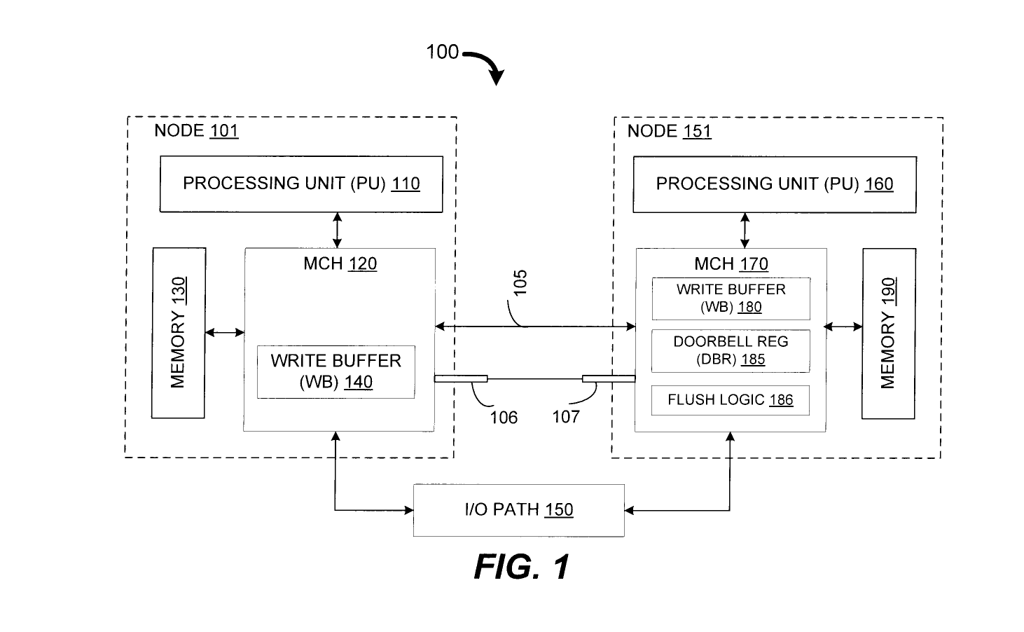

An embodiment of a computer system 100 is illustrated in FIG. 1. In one embodiment, the computer system 100 may comprise a first node 101 and a second node 151.

In one embodiment, the node 101 and 151 may both be operational and one node may take over the task of the other node if the other node fails. In one embodiment, the node 101 may be coupled to the node 151 through an I/O path 150 such as a PCI bridge. Also, the nodes 101 and 151 may be coupled by a non-CPU interface such as an inter-node path 105. In one embodiment, the inter-node path 105 may comprise a system management bus (SMBus).

In one embodiment, the node 101 may comprise a central processing unit (CPU) 110, a memory controller hub (MCH) 120, and a memory 130. In one embodiment, the node 151 may comprise a central processing unit 160, a memory controller hub (MCH) 170, and a memory 190. In one embodiment, the MCH 170 may comprise a doorbell register DBR 185. In one embodiment, the processing unit 110 and 160 may comprise Intel® family of micro-processors such as the Itanium® or Xeon® processors, which may use Intel® Architecture (IA). In one embodiment, the CPUs 110 and 160 may be coupled to the MCHs 120 and 170 using a processor bus.

To flush the write buffers, the CPU 110 may configure registers, for example, in the PCI configuration space that may activate a hardware flushing mechanism to transfer the contents of the write buffer 180 to the memory 190. However, the registers in the PCI configuration space may be accessible only to the CPU 110 and may not be accessible to other devices such as the MCH 120 or the I/O devices coupled to the I/O path 150.

In one embodiment, the CPU 110 may cause the data units from the memory 130 to be transferred to memory 190 along a data transfer path. In one embodiment, the data transfer path may comprise the WB 140, the I/O path 150, and the WB 190. In one embodiment, the CPU 110 may initiate a direct memory access (DMA) transfer to transfer the data units to the memory 190. After the data units are transferred to the write buffer 180, in one embodiment, the CPU 110 may initiate flushing of the write buffer 180. In one embodiment, the write buffers 140 and 190 may include processor caches, I/O buffers provisioned between the point at which the data enters the nodes 151 and 101 and the write buffers 140 and 190, or similar other memory. In one embodiment, the write buffer 180 may be flushed periodically. In one embodiment, the flushing of write buffer 180 may be performed using ‘a pin-activated mechanism’, or ‘a control-register based mechanism’, or ‘an in-band flush mechanism’.

In one embodiment, while using the pin-activated mechanism, the CPU 110 may initiate flushing the contents of the write buffer 180 using a direct hardware logic implementation. In one embodiment, the CPU 110 may perform ‘periodic flushing’ of the write buffer 180. While performing ‘periodic flushing’, in one embodiment, the CPU 110 may activate a first pin 106 of the node 101 coupled to a second pin 107 of the node 151 at periodic intervals. In one embodiment, the activation of the first pin 106 at periodic intervals may cause the contents of the write buffer 180 to be transferred to the memory 190. In one embodiment of an additional ‘flush on trigger’ mechanism, the CPU 110 may receive a trigger caused by the onset of power-down mode and the CPU 110 may activate the pin 106 that may cause the contents of the write buffer 180 to be flushed to a battery-backed up memory 190. In one embodiment, the onset of the power-down mode may be due to failure in the power supply providing service to either of the nodes 101 and 151.

In one embodiment, the CPU 110 may add a flush functionality to be performed prior to the self-refresh functionality associated with the pins 106 and 107. In one embodiment, the CPU 110 may initiate a self-refresh of the memory 190 and the flushing of the write buffer 180 may occur before the memory 190 enters the self-refresh mode. In one embodiment, the memory 190 may be supported by a battery supply.

In other embodiments, while using the control register based mechanism, the CPU 110 may configure a control register such as the door bell register (DBR) 185 in response to receiving a trigger or at pre-specified time intervals. In one embodiment, the trigger may be caused due to onset of the power-down mode of either of nodes 101 and 151. In one embodiment, the CPU 110 may configure the DBR 185, which may cause a sequence of operations to flush the write buffer 180. In one embodiment, the CPU 110 may generate one or more configuration values, which may be used to configure the DBR 185. In one embodiment, the CPU 110 may update a specific bit or bits of the DBR 185 with specific configuration values. In one embodiment, updating of the specific bits or bits may initiate the sequence of operations to flush the write buffer 180. In one embodiment, the CPU 110 may send the configuration values to the DBR 185 using the data transfer path, which may be referred to as an “in-band” transaction. In another embodiment, the CPU 110 may send the configuration values to the DBR 185 over an inter-node path 105, which may be referred to as an “out-of-band” transaction. In one embodiment, the inter-node path 105 may comprise a SMBus interconnect or other similar inter-node interfaces.

In one embodiment, the MCH 120 may also configure the door bell register DBR 185 that may cause a sequence of operations to flush the write buffer 180. In one embodiment, the DBR 185 may be visible or accessible to both the CPU 110 and the non-CPU devices such as the MCH 120. In one embodiment, the specific bit or bits of the DBR 185 may be updated in response to receiving a trigger or at periodic intervals of time, which may cause periodic flushing of the write buffer 180. In one embodiment, the MCH 120 may configure the DBR 185 using the data transfer path, which may be referred to as an “in-band” transaction. In other embodiment, the MCH 120 may configure the DBR 185 using an inter-node path 105, which may be referred to as an “out-of-band” transaction. In one embodiment, the inter-node path 105 may comprise a SMBus interconnect or other similar inter-node interfaces.

In one embodiment, the flushing of write buffer 180 may ensure that the data units are transferred to the memory 190 before the computer system 100 is powered down. However, the memory 190 may be provided with a battery supply, which would preserve the data units transferred to the memory 190 before the computer system 100 is powered down.

In yet other embodiment, while using the in-band mechanism, the CPU 110 may transfer a flush message along the data transfer path. In one embodiment, the CPU 110 may transfer the flush message in response to receiving a trigger or in periodic intervals of time. In one embodiment, the CPU 110 may receive a trigger caused by the onset of power-down mode of either of nodes 101 and 151. However, the memory 190 may be backed-up by battery supply. In one embodiment, the data transfer path may refer to a path over which the data units may be transferred from the memory 140 to the write buffer 180. In one embodiment, the MCH 170 may comprise a flush logic 186, which may decode the flush message and flush the contents of the write buffer 180. In one embodiment, the flush logic 186 may cause the contents of the write buffer 180 to be flushed to the memory 190 in response to receiving the flush message.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
flushing data units from a write buffer of a second node to a memory of the second node,
wherein flushing is initiated by configuring a control register of the second node with a configuration value generated by a first node, and
wherein the configuration value is transferred from the first node over an inter-node path.

2. The method of claim 1, wherein the configuration value is generated by the first node in response to receiving a trigger caused by the onset of power-down mode of the first node, wherein the memory of the second node is coupled to a battery.

3. The method of claim 1, wherein the configuration value is generated by the first node in response to receiving a trigger caused by the onset of power-down mode of the second node, wherein the memory of the second node is coupled to a battery.

4. The method of claim 1, wherein the configuration value is generated by the first node in response to receiving a trigger caused by the onset of power-down mode of the first node and the second node, wherein the memory of the second node is coupled to a battery.

5. The method of claim 1, wherein flushing data units from the write buffer of the second node to the memory of the second node is periodically performed by the first node by configuring the configuration register at pre-specified time intervals.

6. The method of claim 1, wherein the inter-node path comprises a SMBus.

7. The method of claim 5, further comprising transfer of the configuration value from the first node over a data transfer path, wherein the data transfer path is used to transfer the data units from the first node to the write buffer of the second node.

8. The method of claim 1, further comprising generation of the configuration value using a memory controller hub, wherein the first node comprises the memory controller hub.

9. The method of claim 8, wherein the configuration value generated by the memory controller hub is sent over the inter-node path.

10. A method comprising:
sending a flush message over a data transfer path, wherein the flush message is sent from a first node to a second node, and
flushing data units from a write buffer of the second node to a memory of the second node in response to receiving the flush message.

11. The method of claim 10, wherein the flush message is generated by the first node in response to receiving a trigger caused by the onset of power-down mode of the first node, wherein the memory of the second node is coupled to a battery.

12. The method of claim 10, wherein the flush message is generated by the first node in response to receiving a trigger caused by the onset of power-down mode of the second node, wherein the memory of the second node is coupled to a battery.

13. The method of claim 10, wherein the flush message is generated by the first node in response to receiving a trigger caused by the onset of power-down mode of the first node and the second node, wherein the memory of the second node is coupled to a battery.

14. The method of claim 10, wherein flushing data units from the write buffer of the second node to the memory of the second node is periodically performed by the first node by generating the flush message at pre-specified time intervals.

15. The method of claim 10, wherein the flush message is decoded by a flush logic of the second node before flushing data units from the write buffer of the second node to the memory of the second node.

16. A system comprising:
a first node including a first pin, wherein the first node is to activate the first pin, and
a second node including a second pin, wherein the first pin is coupled to the second pin, wherein activating the first pin is to cause flushing data units stored in a write buffer of the second node to a memory of the second node.

17. The system of claim 16, wherein the first mode is to activate the first pin in response to receiving a trigger caused by the onset of power-down mode of the first node, wherein the memory of the second node is coupled to a battery.

18. The system of claim 16, wherein the first mode is to activate the first pin in response to receiving a trigger caused by the onset of power-down mode of the second node, wherein the memory of the second node is coupled to a battery.

19. The system of claim 16, wherein the first node is to activate the first pin at periodic intervals of time, wherein the activation of the first pin at periodic intervals of time is to cause flushing data units from the write buffer of the second node to the memory of the second node.

20. The system of claim 19, wherein the first node is to activate the first pin to cause flushing data units stored in the write buffer of the second node to the memory of the second node before the memory of the second node is to enter a self-refresh mode.
